(19) United States
(12) Patent Application Publication
(10) Pub. No.: US 2015/0151745 A1
(43) Pub. Date: Jun. 4, 2015

(54) VEHICLE BODY VIBRATION CONTROL DEVICE FOR VEHICLE

(71) Applicant: TOYOTA JIDOSHA KABUSHIKI KAISHA, Toyota-shi (JP)

(72) Inventors: Takashi SAITO, Fuji-shi (JP); Hirofumi MOMOSE, Numazu-shi (JP)

(73) Assignee: TOYOTA JIDOSHA KABUSHIKI KAISHA, Toyota-shi (JP)

(21) Appl. No.: 14/554,617

(22) Filed: Nov. 26, 2014

(30) Foreign Application Priority Data
Nov. 29, 2013 (JP) 2013-248609

(51) Int. Cl. B60W 30/02; B60W 10/04; B60W 10/10; B60W 50/06

(52) U.S. Cl. CPC B60W 30/025; B60W 50/06; B60W 10/04; B60W 10/10

(57) ABSTRACT

Provided is a vehicle body vibration control device (10) for a vehicle, a driving unit (16) applying a driving force to a vehicle (12), a driving force control unit (22) controlling the driving unit based on a command driving force, a notch filter (24) configured to receive a signal indicating the request driving force, process the signal indicating the request driving force so as to reduce a frequency component of vibration of a vehicle body, and output the processed signal to the driving force control unit as a signal indicating the command driving force, and a command driving force correction unit (30) configured to correct, when the driving force does not change in spite of the driving operation being conducted by the driver, the command driving force to the request driving force of the driver.

### BACKGROUND OF THE INVENTION

1. Field of the Invention

The present invention relates to a vehicle body vibration control device for a vehicle such as an automobile, and more particularly, to a vehicle body vibration control device configured to suppress vibration of a vehicle body, which is caused by fluctuation in driving force of the vehicle.

2. Description of the Related Art

Vehicles such as automobiles travel by a driving force generated by a driving unit such as an engine. Fluctuation in driving force generated from the driving unit causes loads to be applied on the vehicle body in a fore-and-aft direction and a vertical direction of the vehicle relative to wheels. Thus, pitching vibration occurs in the vehicle body. Therefore, it has been suggested that the pitching vibration of the vehicle body be reduced through appropriate control of a command driving force to the driving unit.

For example, Japanese Patent Application Laid-open No. 2007-237879 filed by the applicant of this application describes a vehicle body vibration control device configured based on the above-mentioned concept. This vehicle body vibration control device includes a request driving force calculation unit configured to calculate a driver's request driving force, a driving unit configured to apply a driving force to a vehicle, a driving force control unit configured to control the driving unit based on a command driving force, and a notch filter configured to receive a signal indicating the request driving force from the request driving force calculation unit. The notch filter has a notch frequency set to a value for reducing a frequency component of vibration of a vehicle body. The notch filter subjects the signal to filtering processing, and outputs the processed signal to the driving force control unit as a signal indicating the command driving force.

According to the vehicle body vibration control device of this type, the signal indicating the driver's request driving force is processed by the notch filter, and the driving unit is controlled based on the command driving force reduced in frequency component of the vibration of the vehicle body. As a result, the pitching vibration of the vehicle body can be reduced.

In vehicles such as automobiles, the driving unit includes a driving source and a driving force transmission unit transmitting the driving force generated by said driving source to drive wheels. Even when driving force transmission unit is in the condition not to transmit the driving force, a driver may conduct driving operation to increase and decrease the request driving force. For example, in a vehicle having an automatic transmission, the driver may conduct driving operation such as racing in the condition where the shift position is set to a parking or a neutral position, so as to check the condition of an engine by means of engine speed and sound change. In a vehicle having a manual transmission, the driver may conduct driving operation to increase engine speed in the condition where the clutch is open, so as to conduct uniform velocity shift change, to check the condition of an engine or to warm up the engine.

However, when the signal indicating the request driving force is processed by the notch filter to reduce the vibration of the vehicle body, the driver's request driving force is smoothed through the filtering processing to generate the command driving force. Consequently, responsiveness of the driving source in increasing and decreasing the driving force to the change of the request driving force is reduced. For example, during increase of the request driving force, the command driving force is controlled to a smaller side compared to the request driving force by filtering processing. Conversely, during decrease of the request driving force, the command driving force is controlled to a larger side compared to the request driving force by filtering processing. Thus, the driver experiences a decrease in responsiveness of the driving unit to the driving operation. As a result, the driver may feel uncomfortable.

### SUMMARY OF THE INVENTION

It is a main object of the present invention to reduce, while suppressing the vibration of the vehicle body as effectively as possible, a risk that a delay in response of a driving unit is caused when a driver conducts driving operation during a vehicle is not travelling and the driver experiences uncomfortable feeling caused by the delay.

The present invention provides a vehicle body vibration control device for a vehicle, comprising: a request driving force calculation unit configured to calculate a request driving force of a driver; a driving unit including a driving source and a driving force transmission unit transmitting the driving force generated by the driving source to drive wheels so as to apply a driving force to the vehicle; a driving force control unit configured to control the driving unit based on a command driving force; and a notch filter configured to receive a signal indicating the request driving force from the request driving force calculation unit, subject said signal to filtering processing, and output the signal subjected to the filtering processing to the driving force control unit as a signal indicating the command driving force, the notch filter having a notch frequency set to a value for reducing a frequency component of vibration of a vehicle body. The vehicle body vibration control device comprises a command driving force correction unit configured to correct, when the driving force transmission unit is in the condition not to transmit the driving force, the command driving force to a value closer to the request driving force of the driver than to the command driving force.

According to the above-mentioned configuration, the signal indicating the request driving force is processed by the notch filter having the notch frequency set to the value for reducing the frequency component of the vibration of the vehicle body, and the processed signal is output to the driving force control unit as the signal indicating the command driving force. When the driving force transmission unit is in the condition not to transmit the driving force, i.e., when the driving force applied to the vehicle does not change in spite of the operation to increase or decrease the request driving force being conducted by the driver, the command driving force is corrected to the value closer to the request driving force of the driver than to the command driving force. In this case, the “value closer to the request driving force of the driver than to the command driving force” is a concept that encompasses the request driving force of the driver.

Accordingly, when the driving force transmission unit is in the condition not to transmit the driving force, a smoothing degree of the driver's request driving force during the generation of the command driving force through the filtering processing can be reduced. This enables less reduction of responsiveness of the driving unit to the driving operation. As a result, according to the present invention, the responsiveness of the driving unit to the driving operation can more effectively enhanced as compared to where the command driving force is not corrected. Thus, it is possible to reduce the risk that a driver experiences uncomfortable feeling caused by the delay in response of the driving unit when the driver conducts driving operation during a vehicle is not travelling.

It is to be noted that when the driving force transmission unit is in the condition not to transmit the driving force, the driving force is not applied to the vehicle. Accordingly, as the vehicle does not travel, the attenuation of the vehicle body vibration is not needed. In consequence, the command driving force being corrected to the value closer to the request driving force of the driver than to the command driving force does not cause any problem.

Also, when the notch degree of the notch filter is set lower, the risk of experience of the driver's uncomfortable feeling due to the delay in response of the driving unit can be reduced. However, in this case, the effect of reducing the frequency component of the vibration of the vehicle body through the notch filter, in other words, a vehicle body damping effect, is inevitably reduced.

On the contrary, according to the above-mentioned configuration, the notch degree of the notch filter is not set lower, and thus the effect of reducing the frequency component of the vibration of the vehicle body through the notch filter is not reduced. As a result, while securing the vehicle body damping effect as high as possible, the risk of experience of the driver's uncomfortable feeling due to the delay in response of the driving unit when the driver conducts driving operation during a vehicle is not travelling can be reduced.

Further, according to one embodiment of the present invention, in the above-mentioned configuration, the command driving force correction unit may be configured to correct the command driving force to the request driving force of the driver.

In the above-mentioned configuration, when the driving force applied to the vehicle does not change in spite of the operation to increase or decrease the request driving force being conducted by the driver, the command driving force is corrected to a value equal to the request driving force of the driver, in other words, a value when the filtering processing is not performed through the notch filter. Accordingly, an influence of the filtering processing can be reduced as compared to, for example, where the command driving force is corrected to a value closer to a command driving force generated through the filtering processing than to the request driving force of the driver. As a result, the risk of experience of the driver's uncomfortable feeling can be reduced more effectively as compared to where the command driving force is corrected to a value other than the request driving force of the driver.

Further, according to one embodiment of the present invention, in the above-mentioned configuration, the vehicle may have a shift position selection unit configured to be operated by a driver, and the condition may be that the shift position is one of a parking position and a neutral position.

According to the above-mentioned configuration, in a situation where the shift position is one of the parking position and the neutral position, the command driving force can be corrected to the value closer to the request driving force of the driver than to the command driving force. In consequence, it is possible to reduce a risk that the driver experiences uncomfortable feeling due to the delay in response of the driving unit when the driver conducts driving operation in a situation where the shift position is one of the parking position and the neutral position.

According to one embodiment of the present invention, in the above-mentioned configuration, the vehicle may have a clutch operation unit configured to be operated by a driver, and the condition my be that said clutch operation unit is on.

According to the above-mentioned configuration, in a situation where the clutch operation unit is on, the command driving force can be corrected to the value closer to the request driving force of the driver than to the command driving force. In consequence, it is possible to reduce a risk that the driver experiences uncomfortable feeling due to the delay in response of the driving unit when the driver conducts driving operation in a situation where the clutch operation unit is on.

### BRIEF DESCRIPTION OF THE DRAWINGS

FIG. 1 is a block diagram illustrating a vehicle body vibration control device for a vehicle according to a first embodiment of the present invention, which is applied to a vehicle having an automatic transmission.

FIG. 2 is a block diagram illustrating a notch filter and a command driving force correction block according to the first embodiment of the present invention.

FIG. 3 is a graph showing an example of frequency characteristics of the notch filter, in other words, a relationship between a frequency and a gain.

FIG. 4 is a flowchart illustrating an example of a command driving force correction routine according to the first embodiment of the present invention.

FIG. 5 is a time chart illustrating an operation of the first embodiment of the present invention in contrast with an operation of a related-art vehicle vibration control device with respect to a case where a driving operation of racing is performed by a driver in a situation where the vehicle is stopped and shift position is set to a parking position.

FIG. 6 is a block diagram illustrating a vehicle body vibration control device for a vehicle according to a second embodiment of the present invention, which is applied to a vehicle having a manual transmission.

FIG. 7 is a block diagram illustrating a notch filter and a command driving force correction block according to the second embodiment of the present invention.

FIG. 8 is a flowchart illustrating an example of a command driving force correction routine executed by the command driving force correction block in the second embodiment of the present invention.

FIG. 9 is a time chart, similar to FIG. 5, illustrating an operation of the second embodiment of the present invention in contrast with an operation of a related-art vehicle vibration control device with respect to a case where uniform velocity shift change by driving operating is performed by a driver in a situation where the vehicle is stopped and the clutch is opened, and then the clutch is connected.

FIG. 10 is a map for calculating a driver's request driving force based on a vehicle speed and an accelerator opening.

### DETAILED DESCRIPTION OF THE PREFERRED EMBODIMENTS

Now, exemplary embodiments of the present invention are described in detail referring to the accompanying drawings.

### First Embodiment

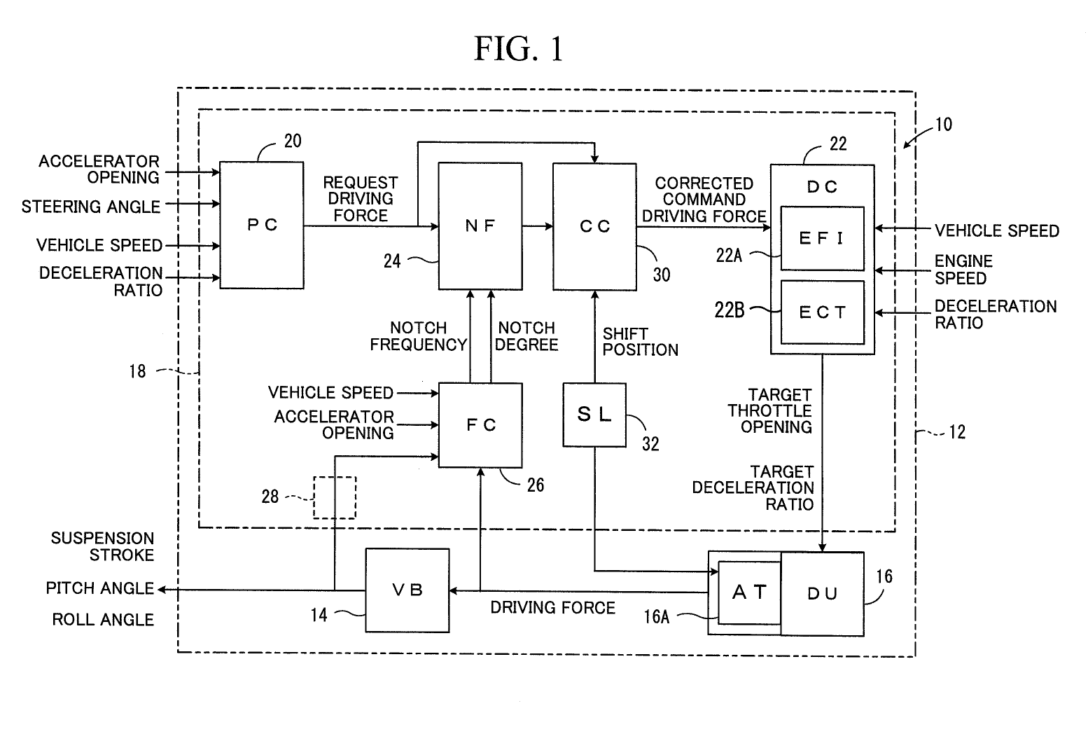

FIG. 1 is a block diagram illustrating a vehicle body vibration control device 10 for a vehicle according to a first embodiment of the present invention, which is applied to a vehicle having an automatic transmission. In FIG. 1, the vehicle body vibration control device 10 is mounted on a vehicle 12, and includes a vehicle body (VB) 14, a driving unit (DU) 16 configured to apply a driving force to the vehicle 12 including the vehicle body 14, and an electronic control unit (ECU) 18 configured to control the driving unit 16.

In the illustrated embodiment, the driving unit 16 includes an engine as a drive source and a transmission as driving force transmission device in combination. However, the driving unit 16 may be another driving unit such as a hybrid system or an electric motor. The transmission may be an automatic transmission such as gear type automatic transmission, continuously variable transmission, dual clutch transmission or the like. The electronic control unit 18 may be an arbitrary electronic control unit having a calculation function and a storage function, for example, as in the case of a microcomputer.

The electronic control unit 18 includes a request driving force calculation block (PC) 20 configured to calculate a driver's request driving force, and a driving force control block (DC) 22 configured to output a signal for controlling a driving force to the driving unit 16. Signals indicating an accelerator opening and a steering angle, which correspond to a driver's steering operation amount, and signals indicating a vehicle speed and a deceleration ratio of the transmission, which correspond to parameters indicating a driving state of the vehicle, are input to the request driving force calculation block 20. The request driving force calculation block 20 calculates a driver's request driving force based on the accelerator opening, the steering angle, the vehicle speed, and the deceleration ratio, or another arbitrary driving force calculation input parameter in addition to those parameters.

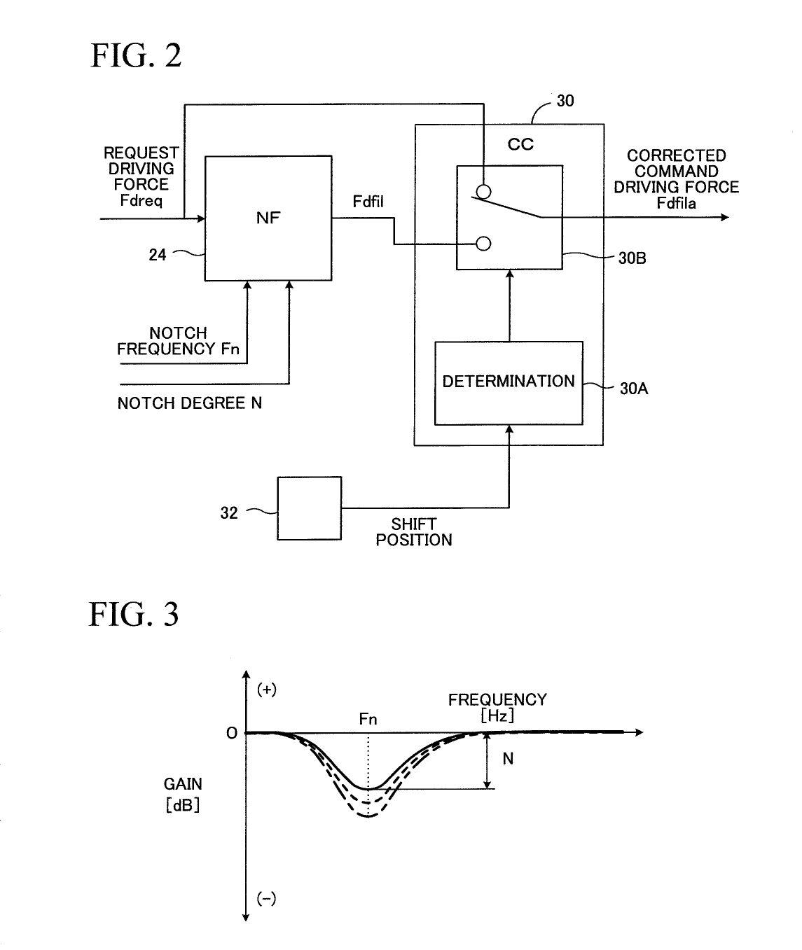

A signal indicating the driver's request driving force is input to a notch filter (NF) 24. The notch filter 24 suppresses or blocks transmission of a notch frequency component among frequency components included in the signal indicating the request driving force to reduce the notch frequency component. In this case, the notch frequency is basically set to a resonance frequency of the vehicle body. The signal indicating the request driving force (command driving force) corrected through processing of the notch filter 24 is input through a command driving force correction block (CC) 30 to the driving force control block 22. The command driving force correction block 30 is described later in detail referring to FIG. 2.

Pitch damping of the vehicle body through the notch filter 24 is filter processing represented by a transfer function H(s) in Expression (1), where ζₚ denotes a pitch damping ratio, ζₘ denotes a sum of the pitch damping ratio ζₚ and a control damping ratio ζₖ, ωₚ denotes a pitch natural frequency, and s denotes a Laplace operator.

$$H ( s ) = \frac{{s}^{2} + 2 {ζ}_{p} {ω}_{p} s + {ω}_{p}^{2}}{{s}^{2} + 2 {ζ}_{m} {ω}_{p} s + {ω}_{p}^{2}} \qquad ( 1 )$$

The filter processing represented by the transfer function in Expression (1) is represented by Expression (2) in terms of discrete-time expression, where yₙ and xₙ respectively denote an output value and an input value, xₙ₋₁ and xₙ₋₂ respectively denote a last input value and an input value before the last input value, and yₙ₋₁ and yₙ₋₂ respectively denote a last output value and an output value before the last output value.

yₙ=aₙxₙ+aₙ₋₁xₙ₋₁+aₙ₋₂xₙ₋₂−bₙ₋₁yₙ₋₁−bₙ₋₂yₙ₋₂ (2)

The filter coefficients aₙ, a_{n- 1}, aₙ₋₂, bₙ₋₁, and bₙ₋₂ in Expression (2) are represented as follows.

$${a}_{n} = \frac{{ω}_{p}^{2} {T}^{2} + 4 {ζ}_{p} {ω}_{p} T + 4}{c}$$

$${a}_{n - 1} = \frac{2 {ω}_{p}^{2} {T}^{2} - 8}{c}$$

$${a}_{n - 2} = \frac{{ω}_{p}^{2} {T}^{2} - 4 {ζ}_{p} {ω}_{p} T + 4}{c}$$

$${b}_{n - 1} = \frac{2 {ω}_{p}^{2} {T}^{2} - 8}{c} = {a}_{n - 1}$$

$${b}_{n - 2} = \frac{{ω}_{p}^{2} {T}^{2} - 4 {ζ}_{m} {ω}_{p} T + 4}{c}$$

$$c = {ω}_{p}^{2} {T}^{2} + 4 {ζ}_{m} {ω}_{p} T + 4$$

The driving force control block 22 includes an electronic fuel injection (EFI) system control unit 22A and an electronic control transmission (ECT) control unit 22B. The driving force control block 22 determines a target throttle opening degree and a target deceleration ratio based on the parameters of the command driving force, the vehicle speed, an engine revolution number, and a deceleration ratio, and the driving force control block 22 outputs signals indicating those target throttle opening and target deceleration ratio to the driving unit 16.

The engine is controlled based on the target throttle opening, and the transmission is controlled based on the target deceleration ratio. Accordingly, the driving unit 16 applies a driving force corresponding to the command driving force to the vehicle 12 including the vehicle body 14. When the driving force is applied to the vehicle 12 and fluctuates, the vehicle body 14 of the vehicle vibrates. In particular, vibration such as pitching vibration or rolling vibration of the vehicle body appears as a change in suspension stroke, pitch angle, or roll angle.

A signal indicating the driving force applied to the vehicle 12 by the driving unit 16, and a signal indicating the change in suspension stroke, pitch angle, or roll angle, which occurs in the vehicle body due to the driving force, are input to a notch filter control block (FC) 26. The notch filter control block 26 variably controls a notch frequency of the notch filter 24. Specifically, the notch filter control block 26 calculates an amplitude distribution of pitching vibration or rolling vibration of the vehicle body with respect to a frequency of the command driving force on the basis of the correspondence between the frequency of the command driving force and vibration of the vehicle body 14, in particular, the pitching vibration or the rolling vibration of the vehicle body. Then, the notch filter control block 26 controls the notch frequency so as to minimize amplitude of the pitching vibration or the rolling vibration of the vehicle body.

For example, the notch filter control block 26 performs frequency analysis by a Fourier transform method for response motion of the vehicle body to a driving force applied to the vehicle in various driving states of the vehicle. Then, the notch filter control block 26 calculates an amplitude distribution of the pitching vibration or the rolling vibration of the vehicle body with respect to the frequency of the command driving force, and controls the notch frequency so as to minimize the amplitude thereof.

In this case, a signal indicating the pitching or the rolling of the vehicle body, which is input to the notch filter control block 26, may be subjected to low-pass filter processing by a low-pass filter as indicated by a broken-line block 28 of FIG. 1. Through the low-pass filter processing, vehicle body vibration of a relatively low frequency of about 1 Hz to 2 Hz, which is easily generated by resonance along with a change in driving operation amount such as the accelerator opening or the steering angle, is efficiently extracted. As a result, the notch frequency can be more accurately controlled.

The control itself of the notch frequency of the notch filter 24 is not a main subject of the present invention. Accordingly, the notch frequency may be calculated through an arbitrary procedure as long as the notch frequency is calculated to a value, for example, corresponding to a resonance frequency of the vehicle body so as to effectively reduce the pitching vibration or the rolling vibration of the vehicle body. For example, as another control procedure, a procedure described in paragraphs [0036] to [0038] of Japanese Patent Application Laid-open No. 2007-237879 filed by the applicant of this application may be used.

The notch filter 24 has its notch frequency controlled by the notch filter control block 26, and a notch degree of the notch filter 24, in other words, an attenuation degree of a component of the notch frequency is controlled depending on increase or decrease of the driver's request driving force, therefore, depending on whether the driver's request is acceleration or deceleration. Notably, the increase or decrease of the driver's request driving force may be determined based on increase or decrease of the accelerator opening. The control of the notch degree based on whether the driver's request is acceleration or deceleration is not a main subject of the present invention. Thus, the notch degree may be calculated through an arbitrary procedure, or set to a fixed value.

FIG. 3 shows frequency characteristics of the notch filter 24, in which Fn denotes a notch frequency. As can be understood from FIG. 3, a notch degree N indicates a depth of a V-shaped notch in the frequency characteristics. As the notch degree is higher, an attenuation degree of a driver's request driving force in the notch frequency is higher.

As illustrated in FIG. 2, the command driving force correction block 30 includes a determination block 30A, a switching block 30B, and a reset block 30C. A signal indicating information of shift position is input to the determination block 30A from a shift position sensor, not shown, provided on a shift lever 32 that is operated by a driver.

The determination block 30A determines whether or not the shift position is parking position or neutral position based on the input information. When the determination block 30A determines that the shift position is parking position or neutral position, the determination block 30A determines that correction of the command driving force needs to be stopped, and outputs, to the switching block 30B, a command to set a corrected command driving force Fdfila to a driver's request driving force Fdreq.

When the switching block 30B has not received, from the determination block 30A, any command to set the corrected command driving force Fdfila to the driver's request driving force Fdreq, the switching block 30B outputs a command driving force Fdfil to the driving force control block 22 as the corrected command driving force Fdfila. On the other hand, when the switching block 30B has received, from the determination block 30A, the command to set the corrected command driving force Fdfila to the driver's request driving force Fdreq, the switching block 30B outputs the request driving force Fdreq to the driving force control block 22 as the corrected command driving force Fdfila.

As apparent from the above description, the request driving force calculation block 20, the driving force control block 22, and the command driving force correction block 30 respectively function as a request driving force calculation unit, a driving force control unit, and a command driving force correction unit of the present invention. The functions of those blocks and the notch filter 24 are achieved under control of the electronic control unit 18. For example, each function is achieved by a calculation control unit such as a microcomputer constructing the electronic control unit 18 in accordance with a control program.

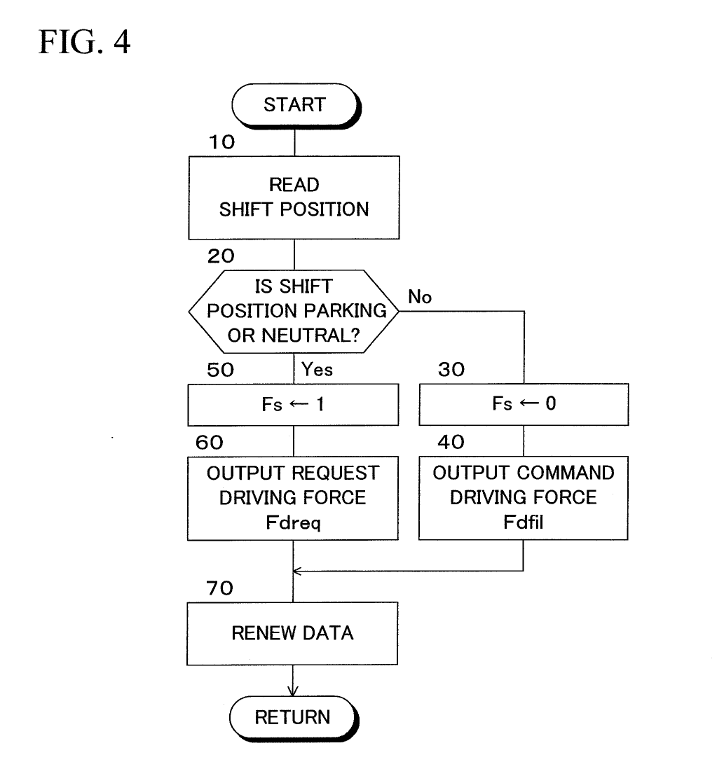

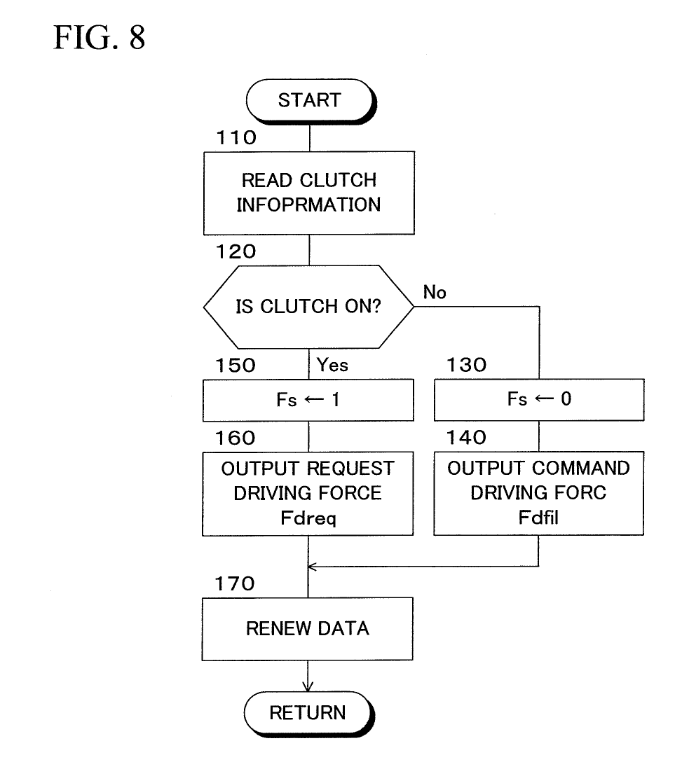

FIG. 4 is a flowchart illustrating an example of a command driving force correction and notch filter resetting routine executed by the command driving force correction block 30 in the first embodiment. Control in the flowchart illustrated in FIG. 4 is started by turning ON an ignition switch (not shown), and is repeatedly executed at each predetermined time interval. In the description of the flowchart illustrated in FIG. 4, the control in the flowchart is simply referred to as control. The same goes to the flowchart illustrated in FIG. 8 and described later.

First, in Step 10, information of the shift position is read. Prior to Step 10, a flag Fs for determining whether or not to stop the correction of the command driving force is reset to 0.

In Step 20, determination is made as to whether or not the shift position is a parking position or a neutral position. When the determination is positive (YES), the control processing proceeds to Step 50. When the determination is negative (NO), the control processing proceeds to Step 30.

In Step 30, the flag Fs is reset to 0. In Step 40, a signal indicating a value of the command driving force Fdfil, in other words, a value generated by subjecting the driver's request driving force Fdreq to the filtering processing, is output to the driving force control block 22 as the corrected command driving force Fdfila.

In Step 50, the flag Fs is set to 1, and in Step 60, a signal indicating the driver's request driving force Fdreq is output to the driving force control block 22 as the corrected command driving force Fdfila.

In Step 70, data used for the filtering processing is renewed in preparation for the next cycle control. Specifically, the input values xₙ and xₙ₋₁ in Expression (2) are rewritten to xₙ₋₁ and xₙ₋₂, respectively.

As apparent from the above description, when the shift position is not parking position nor neutral position, i.e., when the driving force of the vehicle changes if the driving operation is conducted by the driver, in Step 20, negative determination is made. In Step 40, a signal indicating a value of the command driving force Fdfil, in other words, a value generated by subjecting the driver's request driving force Fdreq to the filtering processing, is output to the driving force control block 22 as the corrected command driving force Fdfila. Accordingly, usual vehicle body vibration control is executed by the vehicle body vibration control device 10.

On the contrary, when the shift position is parking position or neutral position, i.e., when the driving force of the vehicle does not change even if the driving operation is conducted by the driver, in Step 20, positive determination is made. In Step 60, a signal indicating the driver's request driving force Fdreq is output to the driving force control block 22 as the corrected command driving force Fdfila.

In consequence, when the driving force of the vehicle does not change even if the driving operation is conducted by the driver, the corrected command driving force Fdfila is set to the driver's request driving force Fdreq that is not processed by the filter and, accordingly, the vehicle body vibration control is not executed by the vehicle body vibration control device 10. As a result, the drive unit does not delay in response with respect to the driving operation by the driver due to the filtering process. Therefore, when the driving force of the vehicle does not change even if the driving operation is conducted by the driver, the driver can be prevented from feeling uncomfortable due to the delay in response of the driving unit such as delay in increasing the engine speed in a situation where the driving operation such as racing is conducted by the driver.

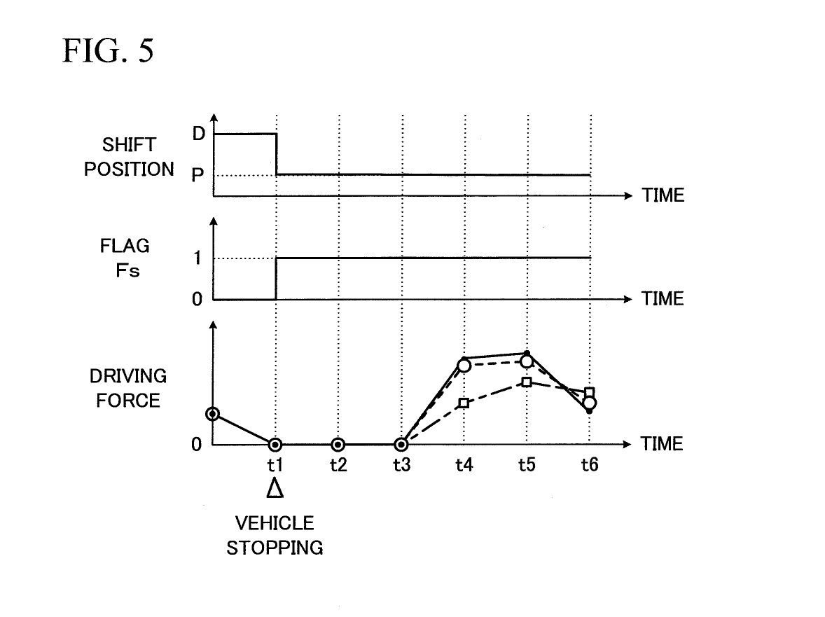

For example, FIG. 5 is a time chart illustrating an operation of the first embodiment of the present invention in contrast with an operation of a related-art vehicle vibration control device with respect to a case where a driving operation of racing is performed by a driver in a situation where the vehicle is stopped and shift position is set to a parking position.

In FIG. 5, the black dot indicates the driver's request driving force Fdreq, and the thin solid line indicates a change of the request driving force Fdreq. The white circle indicates the corrected command driving force Fdfila in the embodiment of the present invention, and the broken line indicates a change of the corrected command driving force Fdfila. The square indicates the command driving force Fdfil, and the alternate long and short dashed line indicates a change of the command driving force Fdfil.

As illustrated in FIG. 5, it is supposed that at time point t1, a shifting operation is performed from a drive position to a parking position, and the flag Fs changes from 0 to 1. It is further supposed that from the time point t1 to time point t3, the driver's request driving force is kept to 0, and at time point t4 and later, a driving operation of racing is performed by the driver.

The command driving force Fdfil at the time point t4 is calculated based on the request driving forces Fdreq and the command driving forces Fdfil at the time points t2 and t3, and thus calculated to a value smaller than the driver's request driving forces Fdreq at the time point t4. Similarly, the command driving force Fdfil at a time point t5 is calculated based on the request driving forces Fdreq and the command driving forces Fdfil at the time points t3 and t4, and thus calculated to a value smaller than the driver's request driving forces Fdreq at the time point t5.

It is further supposed that at the time point t6, the driver's request driving forces Fdreq lowers to a value much smaller than that at the time point t5. The command driving force Fdfil at a time point t6 is calculated based on the request driving forces Fdreq and the command driving forces Fdfil at the time points t4 and t5, and thus calculated to a value larger than the driver's request driving forces Fdreq at the time point t6.

Thus, in the case of the related-art vehicle body vibration control device in which the command driving force Fdfil is not corrected, the responsiveness of the command driving force Fdfil to the driver's driving operation is low, the driver inevitably feels that the driving unit 16 has been deteriorated in responsiveness.

On the contrary, according to the first embodiment of the present invention, the command driving force at the time point t1 and later is corrected to the corrected command driving force Fdfila, and the corrected command driving force Fdfila is set to the driver's request driving force Fdreq, which is not filtered. Accordingly, the driving unit 16 is controlled based on the corrected command driving force Fdfila, and, as a result, is controlled based on the driver's request driving force Fdreq. Therefore, the driver can be prevented from feeling that the driving unit 16 has been deteriorated in responsiveness.

### Second Embodiment

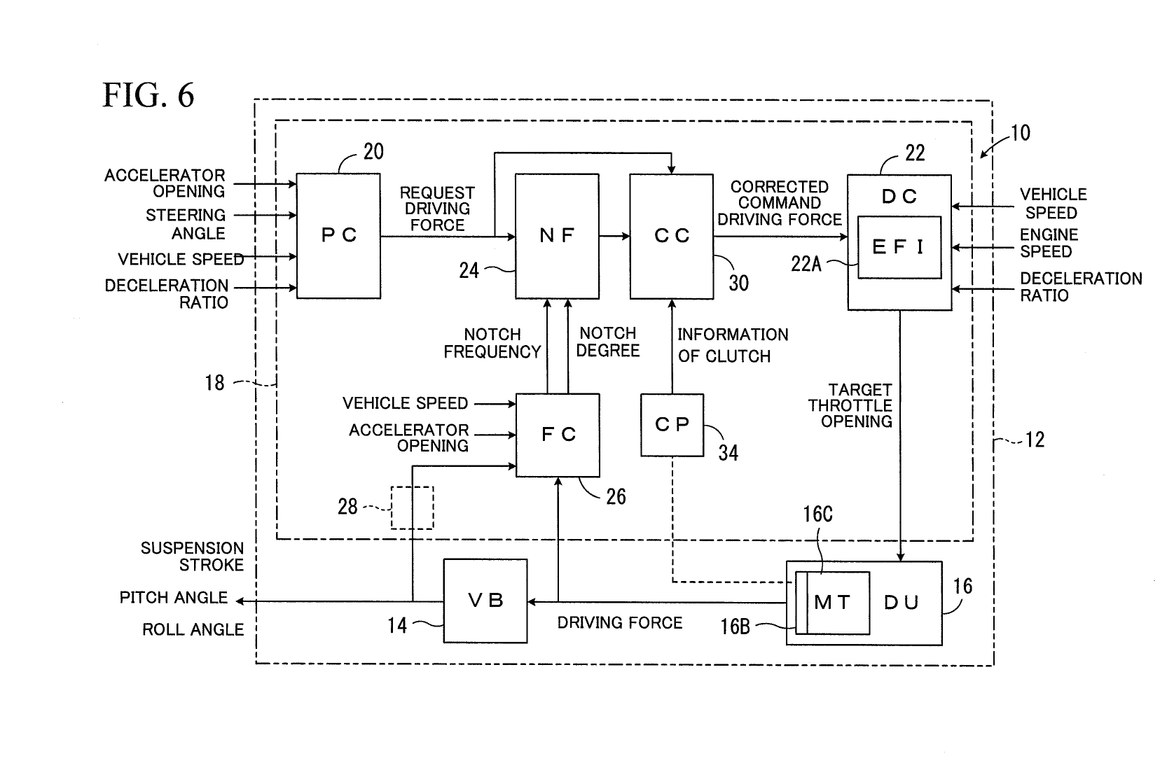

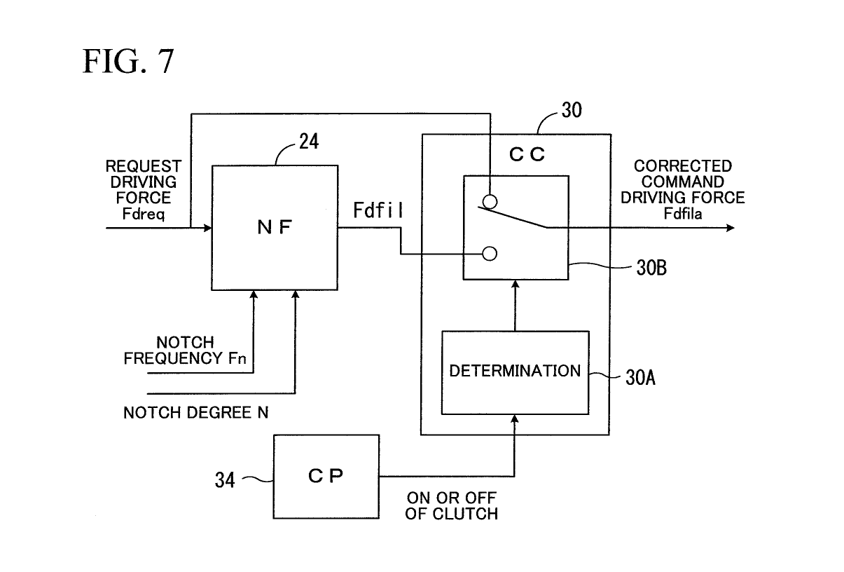

FIG. 6 is a block diagram illustrating a vehicle body vibration control device for a vehicle according to a second embodiment of the present invention, which is applied to a vehicle having a manual transmission. In FIG. 6, units similar to those shown in FIG. 1 are denoted by the same reference numbers as in FIG. 1.

In the second embodiment, the driving unit (DU) 16 includes, in addition to an engine, a manual transmission (MT) 16C having therein a clutch 16B and the manual transmission functions as a driving force transmission unit. As is well known, on and off of the clutch 16B is controlled by a driver by operating a clutch pedal (CP) 34. When the clutch 16B is on, the transmission path of the driving force is shut down and the driving force generated by the engine in the driving unit 16 is not transmitted to drive wheels. On the contrary, when the clutch 16B is off, the transmission path of the driving force is not shut down and the driving force generated by the driving unit 16 is transmitted to drive wheels.

The information of the clutch 16B, i.e., the information of on or off is detected by a clutch switch, not shown, provided on the clutch pedal 34 and is input into the determination block 30A. The determination block 30A determines whether or not the clutch is on the basis of the information of the clutch 16B. When determination block 30A determines that the clutch is on, it further determines that the correction of the command driving force is to be stopped, and oututs a command that the corrected command driving force Fdfila is to be set to the driver's request driving force Fdreq to the switching block 30B.

In the second embodiment also, the corrected command driving force Fdfila is input to the driving force control block 22. However, as the transmission in this embodiment is the manual transmission 16C, the driving force control block 22 calculates a target throttle opening on the basis of the corrected command driving force Fdfila without calculating a target deceleration ratio, and controls the output of the engine in the driving unit 16 based on the target throttle opening.

In the embodiment also, the request driving force calculation block 20, the driving force control block 22, and the command driving force correction block 30 respectively function as a request driving force calculation unit, a driving force control unit, and a command driving force correction unit of the present invention. The functions of those blocks and the notch filter 24 are achieved under control of the electronic control unit 18.

FIG. 8 is a flowchart illustrating an example of a command driving force correction routine executed by the command driving force correction block 30 in the second embodiment of the present invention.

First, in Step 110, the information of the clutch 16B is read. Prior to Step 110, the flag Fs for determining whether or not to stop the correction of the command driving force is reset to 0.

In Step 120, determination is made as to whether or not the clutch 16B is on. When the determination is positive (YES), the control processing proceeds to Step 150. When the determination is negative (NO), the control processing proceeds to Step 130.

Steps 130-170 are conducted in the same manner as in Steps 30-70 in the above-described first embodiment. Accordingly, in Step 140, a signal indicating a value of the command driving force Fdfil is output to the driving force control block 22. However, in Step 160, a signal indicating the driver's request driving force Fdreq is output to the driving force control block 22 as the corrected command driving force Fdfila.

As apparent from the above description, when the clutch 16B is off, i.e., when the driving force of the vehicle changes if the driving operation is conducted by the driver, in Step 120, negative determination is made. In Step 140, a signal indicating a value of the corrected command driving force Fdfila, in other words, a value generated by subjecting the driver's request driving force Fdreq to the filtering processing, is output to the driving force control block 22. Accordingly, usual vehicle body vibration control is executed by the vehicle body vibration control device 10.

On the contrary, when the clutch 16B is on, i.e., when the driving force of the vehicle does not change even if the driving operation is conducted by the driver, in Step 120, positive determination is made. In Step 160, a signal indicating the driver's request driving force Fdreq is output to the driving force control block 22 as the corrected command driving force Fdfila.

In consequence, when the driving force of the vehicle does not changes even if the driving operation is conducted by the driver, the corrected command driving force Fdfila is set to the driver's request driving force Fdreq that is not processed by the filter and, accordingly, the vehicle body vibration control is not executed by the vehicle body vibration control device 10. As a result, the drive unit does not delay in response with respect to the driving operation by the driver due to the filtering process. Therefore, when the driving force of the vehicle does not change even if the driving operation is conducted by the driver, the driver can be prevented from feeling uncomfortable due to the delay in response of the driving unit such as delay in increasing the engine speed in a situation where the driver conducts uniform velocity shift change by driving operation with the clutch being open so as to increasingly adjusting the engine speed.

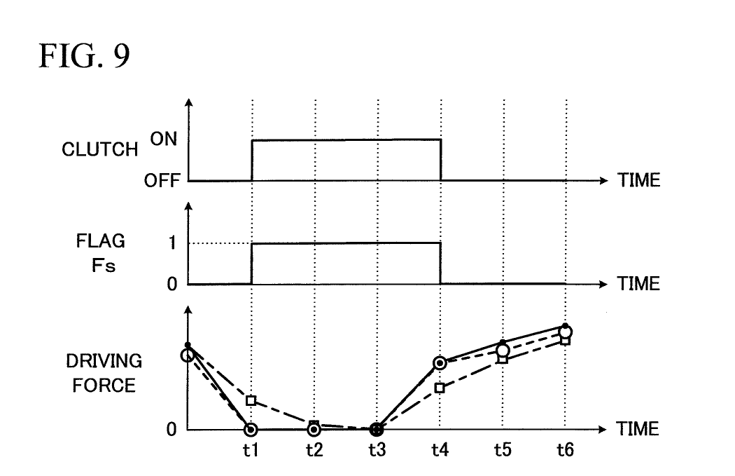

For example, FIG. 9 is a time chart, similar to FIG. 5, illustrating an operation of the second embodiment of the present invention in contrast with an operation of a related-art vehicle vibration control device with respect to a case where uniform velocity shift change by driving operating is performed by a driver in a situation where the vehicle is stopped and the clutch is opened, and then the clutch is connected.

As illustrated in FIG. 9, it is supposed that at time point t1, the clutch changes from off to on, and the flag Fs changes from 0 to 1. It is further supposed that from the time point t1 to time point t3, the driver's request driving force is kept to 0, and at time point t4 and later, a driving operation for increasing the driving force is performed by the driver.

The command driving force Fdfil at the time point t4 is calculated based on the request driving forces Fdreq and the command driving forces Fdfil at the time points t2 and t3, and thus calculated to a value smaller than the driver's request driving forces Fdreq at the time point t4. Similarly, the command driving force Fdfil at a time point t5 is calculated based on the request driving forces Fdreq and the command driving forces Fdfil at the time points t3 and t4, and thus calculated to a value smaller than the driver's request driving forces Fdreq at the time point t5.

Thus, in the case of the related-art vehicle body vibration control device in which the command driving force Fdfil is not corrected, the responsiveness of the command driving force Fdfil to the driver's driving operation is low, the driver inevitably feels that the driving unit 16 has been deteriorated in responsiveness.

On the contrary, according to the second embodiment of the present invention, the command driving force at the time point t1 and later is corrected to the corrected command driving force Fdfila, and the corrected command driving force Fdfila is set to the driver's request driving force Fdreq, which is not filtered. Accordingly, the driving unit 16 is controlled based on the corrected command driving force Fdfila, and, as a result, is controlled based on the driver's request driving force Fdreq. Therefore, as in the first embodiment, the driver can be prevented from feeling that the driving unit 16 has been deteriorated in responsiveness.

In particular, in the first and second embodiments, in Steps 60 and 160, respectively, a signal indicating the request driving force Fdreq is output to the driving force control block 22 as the corrected command driving force Fdfila. As a result, the driving force of the vehicle is not affected by the filtering processing by the notch filter 24. In consequence, as compared to where a value that is closer to the request driving force Fdreq than the command driving force Fdfil but is larger than the request driving force Fdreq is set to the corrected command driving force Fdfila, a risk can more effectively be reduced that the driver feels uncomfortable due to the delay in response of the driving unit,

Notably, as the notch degree of the notch filter 24 is higher, the degree increases in which the driver's request driving force is smoothed in changing by the filtering processing. Accordingly, in order to reduce the delay in response of the driving unit occurring when the driver conducts driving operation during non-travelling period and to reduce a risk that the driver feels uncomfortable due to the delay, the notch degree may be varied in accordance with the result of the determination in Step 20 or 120. That is, when the determination in Step 20 or 120 is negative, the notch degree may be set to the normal value, but when the determination in Step 20 or 120 is positive, the notch degree may be set to a value lower than the normal value.

Further, when the notch degree is variably set as above, irrespective of whether or not the determination in Step 20 or 120 is positive, the corrected command driving force Fdfila may be set to the command driving force Fdfil. In particular, if the notch degree is set to a very small value including 0, when the determination in Step 20 or 120 is positive, the same advantageous effect as in the first embodiment can be achieved.

The specific embodiments of the present invention are described in detail above. However, the present invention is not limited to the above-mentioned embodiments. It is apparent for those skilled in the art that various other embodiments may be employed within the scope of the present invention.

For example, in the above-mentioned first and second embodiments, the correction of the command driving force to the value closer to the driver's request driving force than to the command driving force is achieved by correcting the command driving force generated through the filtering processing. However, when a predetermined shifting operation or a predetermined changing operation for the vehicle traveling mode is performed, the correction may be achieved by lowering the notch degree of the notch filter 24 and calculating the command driving force to a value closer to the driver's request driving force than to the command driving force when the notch degree is not lowered.

In the above-mentioned first and second embodiments, when the shift position is a parking position or a neutral position, and when the clutch is on, respectively, the corrected command driving force Fdfila is set to the driver's request driving force Fdreq. However, the corrected command driving force Fdfila may be set to a value other than the request driving force as long as the value is closer to the driver's request driving force than to the command driving force. For example, as the value other than the request driving force, there may be used a simple average value or a weighted average value of the command driving force Fdfil and the request driving force Fdreq, or a sum of Ka(Fdfil−Fdreq)+Fdreq, which is obtained by adding the request driving force to a value obtained by multiplying a difference between the command driving force Fdfil and the request driving force Fdreq by a coefficient Ka larger than 0 and smaller than 1.

In the above-mentioned first and second embodiments, the command driving force correction block 30 operates between the notch filter 24 and the driving force control block 22 to switch the corrected command driving force Fdfila to the command driving force Fdfil or the request driving force Fdreq. However, the command driving force correction block 30 may operate on a side opposite to the driving force control block 22 with respect to the notch filter 24 to switch inputting of the request driving force Fdreq to the notch filter 24 and to the driving force control bock 22 (a modified example).

According to the first and second embodiments, the notch filter 24 can continue calculation of the filtering processing irrespective of switching of the command driving force correction block 30. Thus, the responsiveness of the vehicle driving force when the request driving force Fdreq is increased or decreased can be set higher than in a case of the modified example.

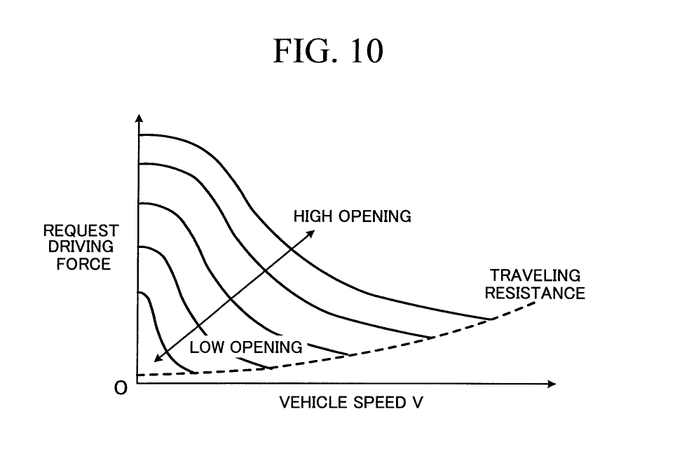

In the above-mentioned first and second embodiments, the driver's request driving force is estimated based on the accelerator opening. However, correction may be performed in such a manner that the driver's request driving force is calculated from a map illustrated in FIG. 10 based on the vehicle speed and the accelerator opening. In FIG. 10, a high opening and a low opening respectively mean a large accelerator opening and a small accelerator opening.

In the above-mentioned first embodiment, when the shift position is a parking position or a neutral position, the corrected command driving force Fdfila is set to the driver's request driving force Fdreq. When the shift position is a reverse travel position, the driving force of the driving source is also transmitted to the drive wheels, although the corrected command driving force Fdfila may be set to the driver's request driving force Fdreq even when the shift position is a reverse travel position.

In the above-mentioned first embodiment, the driving unit 16 includes the engine and the transmission in combination, and signals indicating a target throttle opening and a target deceleration ratio calculated based on the command driving force or the like are output to the driving unit 16. However, when the vehicle body vibration control device of the present invention is applied to a vehicle having a hybrid system mounted thereon, outputs of an engine and an electric motor may be controlled based on the command driving force or the like. When the vehicle body vibration control device of the present invention is applied to an electric vehicle, an output of an electric motor may be controlled based on the command driving force or the like.

In particular, when the vehicle body vibration control device of the present invention is applied to the vehicle having a hybrid system mounted thereon or to the electric vehicle, torque of the electric motor is lowered along with increase of the revolution speed thereof, and thus the notch degree may be set lower as the vehicle speed is higher.

In the above-mentioned embodiment, the vehicle to which vehicle body vibration control device of the present invention is applied may be either of a rear-wheel-drive vehicle, a front-wheel-drive vehicle and a four-wheel-drive vehicle.

1. A vehicle body vibration control device for a vehicle, comprising:
a request driving force calculation unit configured to calculate a request driving force of a driver;
a driving unit including a driving source and a driving force transmission unit transmitting the driving force generated by said driving source to drive wheels so as to apply a driving force to the vehicle;
a driving force control unit configured to control said driving unit based on a command driving force; and
a notch filter configured to receive a signal indicating the request driving force from the request driving force calculation unit, subject said signal to filtering processing, and output the signal subjected to the filtering processing to said driving force control unit as a signal indicating the command driving force, said notch filter having a notch frequency set to a value for reducing a frequency component of vibration of a vehicle body;
wherein said vehicle body vibration control device comprises a command driving force correction unit configured to correct, when said driving force transmission unit is in the condition not to transmit the driving force, the command driving force to a value closer to the request driving force of the driver than to the command driving force.

2. A vehicle body vibration control device for a vehicle according to claim 1, wherein said command driving force correction unit is configured to correct the command driving force to the request driving force of the driver.

3. A vehicle body vibration control device for a vehicle according to claim 1, wherein the vehicle has a shift position selection unit configured to be operated by the driver, and said condition is that the shift position is one of a parking position and a neutral position.

4. A vehicle body vibration control device for a vehicle according to claim 1, wherein the vehicle has a clutch operation unit configured to be operated by the driver, and said condition is that said clutch operation unit is on.

5. A vehicle body vibration control device for a vehicle according to claim 2, wherein the vehicle has a shift position selection unit configured to be operated by the driver, and said condition is that the shift position is one of a parking position and a neutral position.

6. A vehicle body vibration control device for a vehicle according to claim 7, wherein the vehicle has a clutch operation unit configured to be operated by the driver, and said condition is that said clutch operation unit is on.
